(19) United States
(12) Patent Application Publication
(10) Pub. No.: US 2024/0189823 A1
(43) Pub. Date: Jun. 13, 2024

(54) LIDDED VESSEL MADE OF PLASTIC, AND METHOD FOR MARKING A LIDDED VESSEL MADE OF PLASTIC

(71) Applicant: EPPENDORF AG, Hamburg (DE)

(72) Inventors: Nils Gerke, Hamburg (DE); Kai Holl, Hamburg (DE)

(73) Assignee: Eppendorf SE, Hamburg (DE)

(21) Appl. No.: 18/029,233

(22) PCT Filed: Sep. 24, 2021
(86) PCT No.: PCT/EP2021/076327

§ 371 Date: Mar. 29, 2023

(30) Foreign Application Priority Data
Oct. 1, 2020 (EP) 20199531.3

(51) Int. Cl. B01L 3/00

(52) U.S. Cl. CPC B01L 3/50825; B01L 2200/025; B01L 2200/0689; B01L 2300/025; B01L 2300/0858

(57) ABSTRACT

A lidded vessel made of plastic for treating samples in the laboratory having a vessel having a tubular vessel body, a vessel floor at the bottom, a vessel opening at the top, and a circumferential first sealing region on or near the vessel opening, a lid having a lid floor and a circumferential second sealing region for sealing against the first sealing region, at least one apparatus for releasably attaching the lid to the vessel when the first sealing region is in sealing contact with the second sealing region, wherein the lid has, on the upper side, a series of divisions running around the central axis of the vessel for marking an alignment of the lidded vessel in a laboratory device for treating a sample in the lidded vessel and/or for marking a division representing a sample filled into the lidded vessel and/or for marking a division representing a treatment step of a sample in the lidded vessel.

### BACKGROUND OF THE INVENTION

The invention relates to a lidded vessel made of plastic for treating samples in a laboratory and to a method for marking a lidded vessel made of plastic when treating samples in the laboratory. Such lidded vessels are also referred to as “reaction vessels” or, when the sample volume is in the microliter range, as “microreaction vessels.” Lidded vessels are utilized in particular in scientific and industrial laboratories in medical, molecular biological and pharmaceutical areas of application for treating samples.

In sample processing, lidded vessels are frequently marked for clear sample tracking. Due to lack of space and reasons of time, the marking often takes place in the form of a code. This occurs in particular when the vessels are utilized as “transitional vessels,” i.e., only for the partial performance of multiple treatment steps. Therefore, in the case of such lidded vessels, often only a simple series of numbers is used and the complete sample information is documented in a lab log, in a PC, or otherwise. In multistage processing, such “transitional vessels” are often used only for a single work step, before the sample is transferred into another vessel.

Moreover, the alignment of the vessels is important especially during centrifugation, which is one of the primary applications of lidded vessels for sample preparation. The user would like to ensure, through the best possible knowledge of the position of the sample components concentrated through centrifugation, that as little as possible is lost, for example, when the supernatant is removed after centrifugation.

Currently, manual labeling is used for quick, short-term sample marking. This is time-intensive and frequently suffers from lack of readability, since handwriting is very individual and can often not (or no longer) be read well, either later or by different people. This presents the risk of mixing up samples. The small amount of space is also disadvantageous, in particular on the lids of the small-volume lidded vessels with 0.5, 1.5 or 2.0 ml, which makes quick and readable labeling difficult. Marking by means of labeled stickers is also time-intensive and is often problematic with regard to the adhesion of the stickers on the lidded vessel.

EP 2 085 462 A1 describes cell culture dishes, in which a side wall of the base has first markings in the form of numbers from 1 to 12 and the top has a cover wall with second markings in the form of letters and a ruler. The markings serve to describe the position of cells on the dish.

EP 3 130 659 A1 describes a cell culture vessel with an octagonal, prism-shaped cell culture container having planar surfaces, wherein two opposing surfaces are parallel to each other. As a result of the surfaces, suitable cell culture conditions should be created even with a low starting number of cells. The cell culture container should have graduations and a marking on the outside of one of the surfaces. The graduations should enable the amount of cell culture medium and the amount of cells in the cell culture container to be estimated by visual inspection and the markings should enable the respective surfaces to be differentiated.

DE 10 2017 114 251 A1 describes a cell culture bottle with a container for receiving a cell culture medium and a cap mounted on a cap neck of the container. The cap is provided with a protrusion on the outer circumference. Around the cap, the container has a reference marking. The position of the marking in relation to the reference marking shows whether the cap is correctly closed.

DE 10 2017 009 526 B3 describes a container for a liquid with a limited shelf-life comprising packaging for receiving the liquid and a closure for closing the packaging. On an outwardly facing surface of the closure and/or an outer face of the container, fields are arranged, which are marked with at least one number each and can be individually marked for the purpose of displaying the day the packaging was opened. Each of the fields marked with at least one number consists at least partially of paper material and/or plastic that is suitable for manual marking of the field by scratching and/or scoring.

U.S. Pat. No. 2,739,564 described a two-part container for medical capsules, pills, or the like, which is provided with a dose-time-indicating means. For this purpose, the container has time-indicating numbers and graduation lines next to the bottle neck and a closure with an arrow or a recess on a collar for adjusting to the numbers and graduation lines. Conversely, the closure can also have numbers and graduation lines and the container can have an arrow for adjusting to the numbers and graduation lines.

EP 2 449 505 B1 describes a drug container with a cylindrical main body and a metal cap attached thereon. The metal cap has a barcode on the front face, which barcode surrounds a central point so that the information encoded by the barcode can be read along a closed line encircling the central point. The barcode encodes specific information regarding the contained medication.

### BRIEF SUMMARY OF THE INVENTION

Starting from this, the object of the invention is to provide a lidded vessel made of plastic for treating samples in the laboratory and a method for marking a lidded vessel made of plastic when treating samples in the laboratory, which enables a quicker, clearer, and more secure marking of samples and treatment steps and a more precise alignment of the lidded vessel in a laboratory device.

The lidded vessel according to the invention made of plastic for treating samples in the laboratory comprises
a vessel having a tubular vessel body, a vessel floor at the bottom, a vessel opening at the top, and a circumferential first sealing region on or near the vessel opening,
a lid having a lid floor and a circumferential second sealing region for sealing against the first sealing region,
at least one apparatus for releasably attaching the lid to the vessel when the first sealing region is in sealing contact with the second sealing region, characterized in that
the lid has, on the upper side, a series of divisions running around the central axis of the vessel for marking an alignment of the lidded vessel in a laboratory device for treating a sample in the lidded vessel and/or for marking a division representing a sample filled into the lidded vessel and/or for marking a division representing a treatment step of a sample in the lidded vessel.

In the method according to the invention for marking a lidded vessel made of plastic when treating samples in the laboratory, a lidded vessel of the previously described type is filled with sample, the lid is releasably attached to the vessel, the lidded vessel is inserted into the laboratory device and a division is aligned with a reference point of the laboratory device, the division of the lidded vessel aligned with the reference point is marked before or after the lidded vessel is inserted into the laboratory device and/or the lidded vessel is aligned, with a specific division selected by the user for a plurality of treatments of samples in different lidded vessels, to a reference point of the laboratory device, and the sample in the lidded vessel is subjected to a treatment by the laboratory device.

According to the further method according to the invention for marking a lidded vessel made of plastic when treating samples in the laboratory, a lidded vessel of the previously described type is filled with sample, the lid is releasably attached to the vessel, a division representing the sample filled into the lidded vessel is marked before or after the sample is filled into the lidded vessel and/or at least one treatment step is performed, and a division representing the respective treatment step is marked on the upper side of the lid before, after or during the treatment step.

According to the invention, the lidded vessel is provided on the upper side of the lid floor with a series of divisions running around the central axis of the vessel. According to one embodiment, the divisions are graduation lines of a graduation and/or numbers, letters, symbols, or combinations of the aforementioned characters. One embodiment is designed, for example, analogously to a dial, either only with graduation lines, only with numbers, or a combination of graduation lines and numbers. Because the divisions are already present on the lid, the user can clearly mark the sample in the lidded vessel by simply and quickly marking a division. The user can use this to mark the alignment of the lidded vessel in a laboratory device and thereby the effect of the laboratory device on the sample. Furthermore, the user can mark a sample filled into the lidded vessel by marking a division. Finally, the user can mark a treatment step performed with the sample in the lidded vessel by marking a division.

The user has the possibility of positioning the lidded vessel with the sample filled into it simply and quickly in any alignment in a laboratory device. This can be an alignment that the user prefers for performing additional treatment steps in order to, for example, form a pellet made of concentrated sample components at a specific position in the lidded vessel through centrifugation, which facilitates the removal of the supernatant by the user. For example, the user can use the “3 o'clock position” as the outer side of the lidded vessel during centrifugation if this is the optimal alignment of the lidded vessel. In this case, the lidded vessel is aligned such that the division assuming the “3 o'clock position” is aimed outwards in the direction of the centrifugal force. Any other alignment can also be made just as well without additional labeling. In particular when the user always chooses the same preferred alignment for treating a plurality of samples in different lidded vessels, the marking of the division selected for this alignment can also be dispensed with. Furthermore, the user can position the lidded vessel in the laboratory device without aligning the division and document the alignment in the laboratory device. For this purpose, the user can, for example, take a photo of the upper side of the lidded vessel or the lidded vessels in the laboratory device or write down the alignment of each lidded vessel. The user can also document an alignment of the lidded vessel in the laboratory device that they have chosen, for example, in one of the previously described ways. Furthermore, the positioning of the lidded vessel or the lidded vessels in the laboratory device can be documented automatically by means of a camera.

The invention enables simpler and quicker marking than manual labeling or attaching stickers. The marking is also clearer, since the risk of mixing up samples due to poor manual labeling can be avoided. The alignment of the sample in the centrifuge rotor can also take place in a simpler, quicker, and clearer manner. Additional advantages are that an embodiment as a dial or similar can be implemented by the user intuitively and without further explanation. The technical implementation can take place with correspondingly adapted injection molding tools without increased production effort.

According to one embodiment of the invention, the division is a series of graduation lines of a graduation and/or of numbers, letters, symbols, or combinations of the aforementioned characters running around the central axis of the vessel. By means of the graduation lines and/or characters, an alignment of the vessel can be particularly well marked. Graduation lines can also be used to mark the filled-in samples in each case, in particular in that different positions of graduation lines are assigned to different samples. The positions of the graduation lines can be established in relation to a specific reference position of the lidded vessel, in particular in relation to a hinge between the lid and the vessel, a snap-on connection between the lid and the vessel, or an additional marking on the vessel or lid. According to another embodiment, the reference position is a specific division that differs from the other divisions, for example, a longer graduation line or a larger number. Preferably, numbers, letters, or symbols are used to mark a filled-in sample or a treatment step.

According to another embodiment, the upper side of the lid can be marked at the divisions by means of ink or dye or paint or a laser beam. For this purpose, the lid of the vessel can consist of a plastic, have a surface texture, or have a coating on which the ink, dye, or paint adheres well. According to another embodiment, the lid has a greater roughness at the divisions than in the remaining regions of the upper side of the lid. The increased roughness at the divisions is advantageous for permanent marking by means of ink, dye, or paint.

According to another embodiment, the divisions are designed on the upper side of the lid in one or more of the following ways: Indentations in the upper side of the lid, elevations on the upper side of the lid, a print on the upper side of the lid, at least one clip clipped into the lid or clipped onto the lid, at least one plug element connected to at least one plug structure of the lid, multiple structural elements of the lid that can be bent over or broken off. Indentations have the advantage that they enable smooth surfaces, on which laboratory gloves are not ripped. Furthermore, ink, dye, or paint can be introduced into indentations, for example, by going over indentations by means of a fibertip pen, in a manner protected from unintentionally being wiped off. Elevations on the upper side of the lid enable marking by completely or partially destroying elevations, for example, by scratching or shaving them off or removing them by means of a laser beam. Furthermore, elevations can also be marked with ink, dye, or paint. A print can be marked by scratching off, rubbing off, or other destruction or by striking through, underlining, circling, or other processing by means of a writing tool or laser beam. A clip can be clipped into the lid or clipped onto the lid in various positions for the purpose of marking. The clip is, for example, a clamp or a bracket that can be clamped onto an edge of the lid or clamped into an opening of the lid. The plug element is, for example, a pin or a sleeve, which can be selectively plugged into plug openings or plugged onto protruding plug pegs at different positions of the lid. In this case, the plug openings or plug pegs are the plug structures of the lid. Furthermore, the plug element can be a disc with a division that can be clamped into a plug receptacle of the lid at a specific or in multiple different positions. Furthermore, the plug element can be a ring with a position mark or with multiple divisions, which ring can be plugged into an annular groove on the upper side of the lid in a specific position or in various rotary positions or which has at least one pin or another plug element on the underside, with which it can be plugged into one or more plug openings in a specific position or in various positions. Furthermore, the division can by formed by multiple structural elements on the upper side of the lid, which can be bent over or broken off or destroyed by hand or, for example, by means of a writing device. The structural elements can be, for example, pegs or small plates (flags) that protrude vertically upwards or radially outwards from the lid. Furthermore, the structural elements can be bars that extend transversely across one or more grooves in the upper side of the lid and can be destroyed, for example, by means of a writing device.

According to another embodiment, the structures, which can be bent over or broken off or destroyed, are connected to the lid via a predetermined bending point or a predetermined breaking point. The predetermined bending point or predetermined breaking point is a weakening of the connecting structure provided by design, which facilitates the bending or breaking of the structural element.

The indentations can be formed in the upper side of the lid during injection molding by elevations of the shaping surface of the injection molding tool and/or the elevations can be formed on the upper side of the lid by indentations in the shaping surface of the injection molding tool.

According to another embodiment, the lid has, protruding from the underside of the lid floor, a plug and/or collar, with which the lid can be attached releasably to the tubular vessel. In this case, the lid can be designed with an overall plug-like and/or cap-like shape.

According to another embodiment, the lidded vessel is a clamped lidded vessel or a screw-on lidded vessel. In the embodiment as a clamped lidded vessel, the lid is attached to the vessel by clamping. Clamping can take place through a frictional connection between the first sealing region and the second sealing region. In the embodiment as a screw-on lidded vessel, the lid and the vessel have corresponding threads that enable the lid and the vessel to be screwed together.

According to another embodiment, the lidded vessel is a snap-on lidded vessel. In this case, the lid and the vessel have snap elements that enable a snap-on connection between the lid and the vessel.

According to another embodiment, the lid is connected to the vessel by a hinge. In the case of a clamped lidded vessel or a snap-on lidded vessel, the hinge can be integrally connected to the lid and the vessel. In the case of a screw-on lidded vessel, the hinge can be integrally connected to the lid or to the vessel and connected to the respective other part by a ring to enable the lid to be screwed onto the vessel.

According to another embodiment, the first sealing region is arranged on the inner circumference of the vessel body and the second sealing region is arranged on the outer circumference of the plug. According to another embodiment, the first sealing region is arranged on the upper edge of the vessel body around the vessel opening and the second sealing region is arranged on the underside of the lid floor. According to another embodiment, the first sealing region is arranged on the inner circumference of the collar and the second sealing region is arranged on the outer circumference of the vessel body.

According to another embodiment, the apparatus for releasably attaching the lid to the vessel when the first sealing region is in sealing contact with the second sealing region is a frictional connection between the sealing regions of the lid and the vessel and/or a snap-on connection between the lid and the vessel and/or a screw-on connection between the lid and the vessel.

According to another embodiment, the numbers, letters, symbols, or combinations of the aforementioned characters are arranged on the upper side of the lid in a series running around the central axis of the vessel at, on, or between the graduation lines of the graduation. This enables simple, precise, and obvious markings for the alignment of the lidded vessel in the laboratory device for a filled-in sample and for a treatment step.

According to another embodiment, the characters are aligned such that they are upright when the upper side of the lid is aligned vertically and the hinge is arranged upwards, or the upper side of the lid is arranged in another defined alignment. This facilitates recording and marking of the characters by the user.

According to another embodiment, the graduation is designed such that a graduation line is aligned on the center of the hinge or two graduation lines are arranged symmetrically on both sides of the middle of the hinge. In this case, the hinge can be used as the reference position for the different graduation lines.

According to another embodiment, the vessel has at least one marking on the outer circumference and the lid can be releasably and sealingly attached to the vessel with a specific division aligned with the marking. By aligning the division with the marking, the lid is brought into a defined position in relation to the vessel. This is particularly advantageous in the case of screw-on lidded vessels, clamped lidded vessels, or snap-on lidded vessels, which can be closed in various positions to ensure a defined alignment of the division in relation to the vessel, in which the division can be used for the marking.

According to another embodiment, the divisions are distributed uniformly around the central axis of the vessel, wherein preferably a total of four divisions, ten divisions, or twelve divisions are present.

In one embodiment of the method according to the invention, a specific division on the lid is aligned with a marking of the vessel and, in this state, the lidded vessel is inserted into the laboratory device and a division is aligned with the reference point of the laboratory device. As a result, the lid can be brought into a defined alignment with the vessel in lidded vessels in which the lid can be attached to the vessel in different closing positions.

According to another embodiment, a division is marked in that, in at least one indentation on the upper side of the lid, ink or dye or paint is introduced or marked by means of a laser beam and/or at least one elevation on the upper side of the lid is completely or partially destroyed and/or at least one print on the upper side of the lid is marked or completely or partially destroyed with ink or dye or paint or by means of a laser beam and/or a structural element that can be bent over or separated is bent over or separated.

### BRIEF DESCRIPTION OF THE SEVERAL VIEWS OF THE DRAWINGS

The invention is explained in more detail below based on the accompanying drawings of exemplary embodiments. In the drawings:

FIG. 1a-d show a lidded vessel with numbers and symbols with the lid folded open in a front view (FIG. 1a), a view from the left side (FIG. 1b), a view from the right side (FIG. 1c), and a plan view (FIG. 1d);

FIG. 2a-g show an alternative lid only with numbers for the same lidded vessel in all main views and in a perspective view obliquely from the front and from the side;

FIG. 3a-g show an alternative lid with numbers and letters for the same lidded vessel in all main views and in a perspective view obliquely from the front and from the side;

FIG. 4a-e show a second lidded vessel with graduation lines of a graduation with the lid folded open in a front view (FIG. 4a), a view from the left side (FIG. 4b), a view from the right side (FIG. 4c), a section along the line d-d from FIG. 4c (FIG. 4d), and a plan view (FIG. 4e)

### DETAILED DESCRIPTION OF THE INVENTION

In the present application, the designations “vertical” and “horizontal,” “upper” and “lower,” designations derived therefrom such as “upper side” and “underside” refer to a lidded vessel with a closed lid, in which the axis of the tubular vessel body is aligned vertically and the vessel floor is arranged below the lid floor.

In the exemplary embodiments, the lidded vessel has a vessel 1 with a tubular vessel body 2, which has a vessel floor 3 at the bottom, a vessel opening 4 at the top, and a strip-shaped circumferential first sealing region 5 on the inner circumference somewhat below the vessel opening 4.

Furthermore, the lidded vessel comprises a lid 6, which has a lid floor 7 and a hollow plug 8 protruding from the underside of the lid floor 7. The plug 8 has, on the outer circumference, a circumferential sealing bead 9, which forms a second sealing region 10.

The lid 6 and the vessel 1 are integrally connected to each other at an edge via a band-shaped hinge 11.

On the side lying opposite the hinge 11, the vessel 1 has a first snap element 12 and the lid 6 has a second snap element 13 of a snap-on connection 14 between the lid 6 and the vessel 1. When the first and second snap elements 12, 13 are snapped together, the first sealing region 5 is located in sealing contact with the second sealing region 10. At the same time, the snap-on connection 14 is an apparatus for releasably attaching 15 the lid 6 to the vessel 1.

A circumferential series of divisions 16 is arranged in each case on the upper side of the lid 6, which divisions are designed, for example, as indentations. The divisions 16 comprise numbers 17 from 1 to 9 and three different symbols 18 (square, circle, triangle), which are each aligned so that they are upright when the upper side of the lid 6 is aligned vertically and the hinge 11 is arranged upwards.

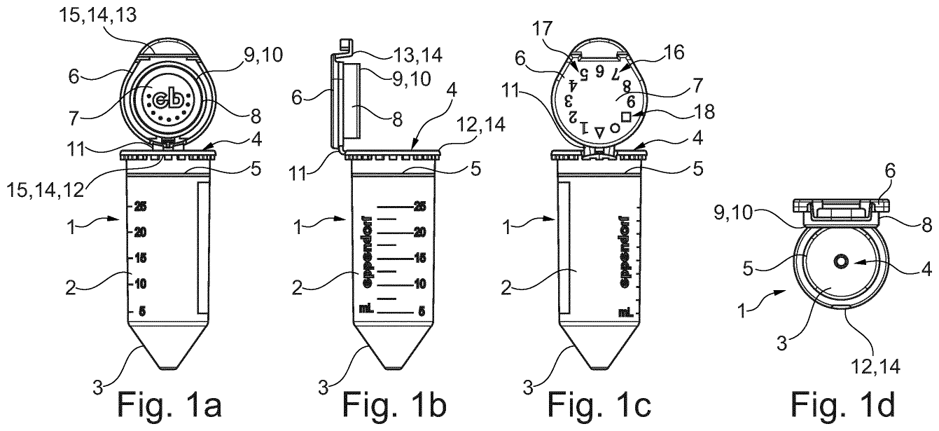

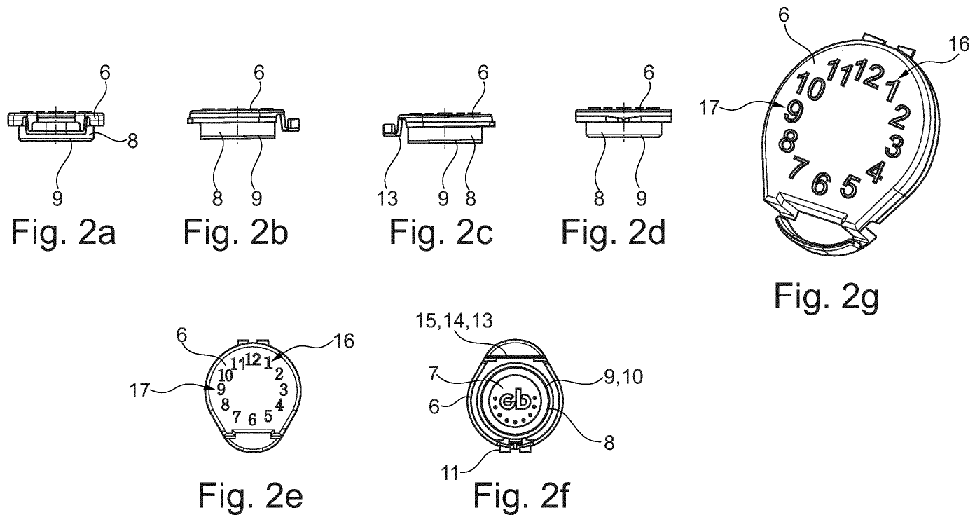

In the exemplary embodiment from FIG. 2, the divisions 16 are designed exclusively as numbers 17 from 1 to 12, in the single difference from FIG. 1.

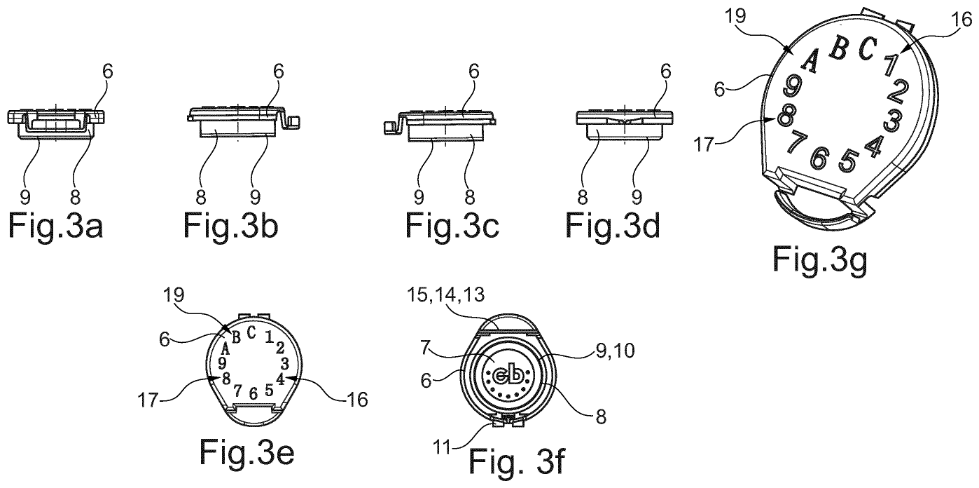

In the exemplary embodiment from FIG. 3, the divisions 16 are designed as a series of numbers 17 from 1 to 9 and letters 19 from A to C.

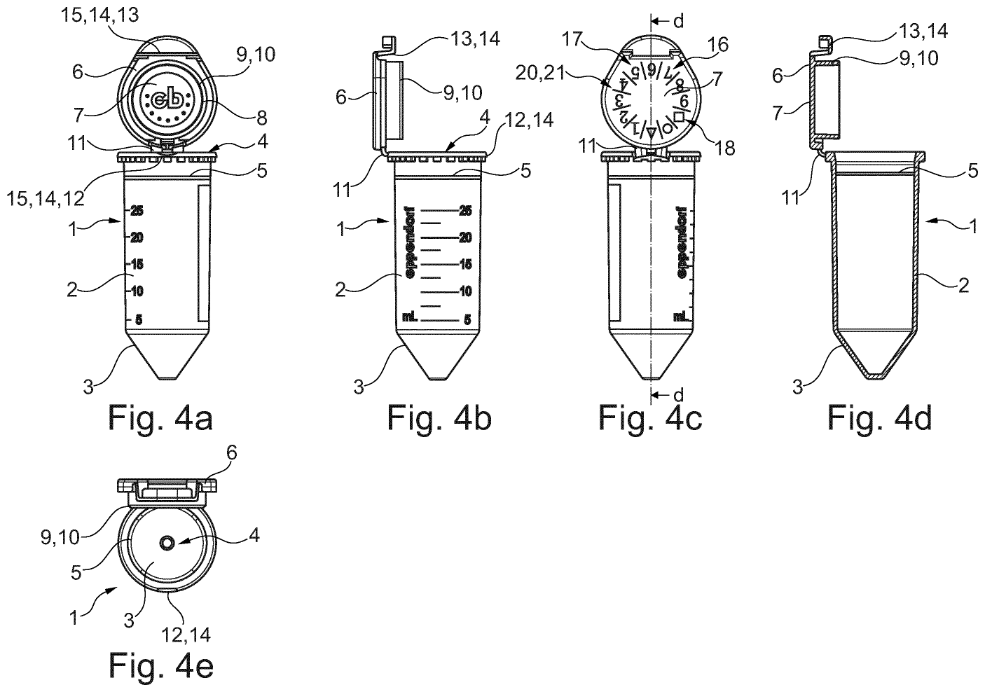

In the exemplary embodiment from FIG. 4, the divisions 16 each comprise straight graduation lines 20 of a graduation 21, which extend in the radial direction in relation to the central axis of the vessel 1. The graduation lines 20 are arranged such that two graduation lines 20 are arranged symmetrically on both sides of the middle of the hinge 11. Furthermore, the divisions 16 comprise numbers 17 from 1 to 9 and symbols 18 (square, circle, triangle), which are each arranged between two adjacent graduation lines 20, such as on the dial of a watch.

The series of numbers 17 begins with the number 1 hinge 11 and continues clockwise. The symbols 18 are also arranged clockwise around the center of the central axis of the vessel 1, wherein the last symbol 18 (triangle) is located in the 12 o'clock position.

One of the divisions 16 can be used for the alignment to a reference point in a laboratory device in the different exemplary embodiments. In the exemplary embodiments from FIGS. 1 to 5 one of the numbers 17, in the exemplary embodiment from FIGS. 1 and 4 one of the symbols 18, in the exemplary embodiment from FIG. 3 one of the letters, and in the exemplary embodiment from FIG. 4 one of the graduation lines 20 can be used. The clear arrangement of each graduation line 20 between adjacent numbers 17 or, respectively, letters 19 facilitates the clear assignment of the respective graduation line 20. Moreover, the division 16 used in each case for the alignment can be marked, for example, by going over it by means of a fibertip pen. Alternatively, the user uses the same specific selected division 16 for the alignment with the reference point when treating different samples in different lidded vessels without marking the selected division 16.

In particular the numbers 17, symbols 18 or, respectively, letters 19 can be used to mark samples received and/or treatment steps performed. In the exemplary embodiment from FIG. 2, a specific number 17 can mark a specific sample and/or a specific treatment step. In the exemplary embodiment from FIG. 3, a specific number 17 can refer to the treatment step and a specific letter 19 can refer to the sample used or vice versa. The respective characters 22 (for example, numbers 17, letters 19, symbols 18, or combinations) can also be marked by going over them by means of a fibertip pen. Alternatively, a graduation line 20 or a character 22 can be marked by at least partially destroying it, in particular when the graduation lines 20 and the characters 22 are designed as elevations on the upper side of the lid 6.

### LIST OF REFERENCE SIGNS

1 Vessel
2 Vessel body
3 Vessel floor
4 Vessel opening
First sealing region
6 Lid
7 Lid floor
8 Plug
9 Sealing bead
10 Second sealing region
11 Hinge
12 First snap element
13 Second snap element
14 Snap-on connection
15 Attaching
16 Divisions
17 Numbers
18 Symbol
19 Letters
20 Graduation lines
21 Graduation
22 Characters

1. A lidded vessel made of plastic for treating samples in the laboratory, comprising
vessel (1) having a tubular vessel body (2), a vessel floor (3) at the bottom, a vessel opening (4) at the top, and a circumferential first sealing region (5) on or near the vessel opening (4),
a lid (6) having a lid floor (7) and a circumferential second sealing region (10) for sealing against the first sealing region (5),
at least one apparatus for releasably attaching (15) the lid (6) to the vessel (1) when the first sealing region (5) is in sealing contact with the second sealing region (10),
and wherein
the lid (6) has, on the upper side, a series of divisions (16) running around the central axis of the vessel (1) for marking an alignment of the lidded vessel in a laboratory device for treating a sample in the lidded vessel and/or for marking a division (16) representing a sample filled into the lidded vessel and/or for marking a division (16) representing a treatment step of a sample in the lidded vessel.

2. The lidded vessel according to claim 1, in which the divisions (16) are a series of graduation lines (20) of a graduation (21) and/or numbers (17), letters (19), symbols (18), or combinations of the aforementioned characters (22) running around the central axis of the vessel (1).

3. The lidded vessel according to claim 1 or 2, in which the upper side of the lid (6) can be marked at the divisions (16) by means of ink or dye or paint or a laser beam.

4. The lidded vessel according to claim 1, in which the divisions (16) are designed on the upper side of the lid (6) in one or more of the following ways: Indentations in the upper side of the lid (6), elevations on the upper side of the lid (6), a print on the upper side of the lid (6), a clip clipped into the lid (6) or clipped onto the lid, at least one plug element connected in a plugged manner to at least one plug structure of the lid, multiple structural elements of the lid that can be bent over or broken off.

5. The lidded vessel according to claim 1, with at least one of the following features:
the lid (6) has, protruding from the underside of the lid floor (7), a plug (8) and/or collar, with which the lid (6) can be attached releasably to the tubular vessel (1),
the lidded vessel is a clamped lidded vessel or a screw-on lidded vessel,
the lidded vessel is a snap-on lidded vessel,
the lid is connected to the vessel by a hinge (11),
the first sealing region (5) is arranged on the inner circumference of the vessel body (2) and the second sealing region (10) is arranged on the outer circumference of the plug (8) and/or the first sealing region (5) is arranged around the vessel opening (4) on the upper edge of the vessel body (2) and the second sealing region (10) is arranged on the underside of the lid floor (7) and/or the first sealing region (5) is arranged on the inner circumference of the collar and the second sealing region is arranged on the outer circumference of the vessel body (2),
the apparatus for releasably attaching (15) the lid (6) to the vessel (1) when the first sealing region (5) is in sealing contact with the second sealing region (10) is a frictional connection between the sealing regions of the lid and the vessel and/or a snap-on connection (14) between the lid (6) and the vessel (1) and/or a screw-on connection between the lid (6) and the vessel (1).

6. The lidded vessel according to claim 2, in which the numbers (17), letters (19), symbols (18), or combinations of the aforementioned characters (22) are arranged on the upper side of the lid (6) in a series running around the central axis of the vessel (1) at, on, or between the graduation lines (20) of the graduation (21).

7. The lidded vessel according claim 2, in which the characters (22) are aligned such that they are upright when the upper side of the lid is aligned vertically and the hinge (11) is arranged upwards or the upper side of the lid is arranged in another defined alignment.

8. The lidded vessel according to claim 2, in which the graduation (18) is designed such that a graduation line (20) is aligned with the middle of the hinge (11) or two graduation lines (20) are arranged symmetrically on both sides of the middle of the hinge (11).

9. The lidded vessel according to claim 1, in which the vessel (1) has, on the outer circumference, at least one marking and the lid (6) can be releasably and sealingly attached to the vessel (1) with a specific division (16) aligned with the marking.

10. The vessel according to claim 1, in which the divisions (16) are distributed uniformly around the central axis of the vessel (1), wherein preferably a total of four divisions, ten divisions, or twelve divisions are present.

11. A method for marking a lidded vessel made of plastic when treating samples in the laboratory, in which a lidded vessel according to claim 1 is filled with sample, the lid is releasably attached to the vessel, the lidded vessel is inserted into the laboratory device and a division is aligned with a reference point of the laboratory device, the division of the lidded vessel aligned with the reference point is marked before or after the lidded vessel is inserted into the laboratory device and/or the lidded vessel is aligned, with a specific division selected by the user for treating a plurality of samples in different lidded vessels, with a reference point of the laboratory device, and the sample in the lidded vessel is subjected to a treatment by the laboratory vessel.

12. The method according to claim 11, in which a specific division on the lid is aligned with a marking of the vessel and, in this state, the lidded vessel is inserted into the laboratory device and a division is aligned with a reference point of the laboratory device.

13. A method for marking a lidded vessel made of plastic when treating samples in the laboratory, in which a lidded vessel according claim 1 is filled with sample, the lid is releasably attached to the vessel, a division representing the sample filled into the lidded vessel is marked before or after the sample is filled into the lidded vessel and/or at least one treatment step is performed, and a division representing the respective treatment step is marked on the upper side of the lid before, after or during the treatment step.

14. (canceled)

15. The method according to claim 11, in which a division is marked in that at least one indentation on the upper side of the lid is completely or partially filled with ink or dye or paint and/or at least one elevation on the upper side of the lid is completely or partially destroyed and/or at least one print on the upper side of the lid is marked with ink or dye or paint or completely or partially destroyed.
